(19) United States
(12) Patent Application Publication
(10) Pub. No.: US 2007/0188021 A1
(43) Pub. Date: Aug. 16, 2007

(54) Vehicle attitude control device

(75) Inventors: Kazuya Maki, Nagoya-city (JP); Yasuo Takahara, Anjo-city (JP)

Correspondence Address: POSZ LAW GROUP, PLC, 12040 SOUTH LAKES DRIVE, SUITE 101, RESTON, VA, 20191, US

(73) Assignee: ADVICS CO., LTD., Kariya-city (JP)

(21) Appl. No.: 11/700,933

(22) Filed: Feb. 1, 2007

(30) Foreign Application Priority Data
Feb. 15, 2006 (JP) 2006-37995

(51) Int. Cl. B60T 13/00

(52) U.S. Cl. 303/186; 303/9.62

(57) ABSTRACT

A control portion stores an actual brake force distribution characteristic line indicating relation between a front brake force allocated to the front wheel and a rear brake force allocated to the rear wheel, wherein the actual brake force distribution characteristic line is determined based on an ideal brake force distribution characteristic line so that, in achieving a given deceleration, a ratio of the front brake force to the rear brake force becomes smaller in the case that the distribution is calculated by using the actual brake force distribution characteristic line than in the case that the distribution is calculated by using the ideal brake force distribution characteristic line. The control portion calculates the distribution by using the actual brake force distribution characteristic line and determines, based on the calculated distribution, the wheel cylinder pressures to be generated at the front wheel cylinder the rear wheel cylinder.

### CROSS REFERENCE TO RELATED APPLICATION

This application is based on and incorporates herein by reference Japanese patent application No. 2006-037995 filed on Feb. 15, 2006.

### FIELD OF THE INVENTION

The present invention relates to a vehicle attitude control device for improving attitude of a vehicle in braking.

### BACKGROUND OF THE INVENTION

In a conventional braking operation of a vehicle, pressures (hereinafter referred to as W/C pressures) at wheel cylinders (hereinafter referred to as W/Cs) installed to the front and rear wheels are controlled so that brake forces are generated in accordance with an actual brake force distribution characteristic line (hereinafter referred to as an ABFD characteristic line) shown in FIG. 16 which is determined based on an ideal brake force distribution characteristic line also shown in FIG. 16. The ideal brake force distribution characteristic line is a line on which the front and rear wheels locks simultaneously.

The ABFD characteristic line is determined so that it basically indicates generating, at the W/Cs for the front and rear wheels, similar W/C pressures to each other. However, in the case that the brake forces are strong, the ABFD characteristic line allocates stronger brake forces to the front wheels than the rear wheels, so that the rear wheels does not lock faster than the front wheels. More specifically, in achieving a given deceleration, a ratio of the braking forces allocated to the front wheels to the total brake force becomes always larger in the case that the brake force distribution is calculated by using, as described above, the conventional ABFD characteristic line than in the case that the brake force distribution is calculated by using the ideal brake force distribution characteristic line. In other words, in achieving a given deceleration, the brake force distribution is always weighed more significantly to the rear wheels in the case that it is calculated by using the conventional ABFD characteristic line than in the case that it is calculated by using the ideal brake force distribution characteristic line.

When braking forces are generated at the wheels, a nose diving phenomenon occurs in which the body of the vehicle is elevated and the head (also called as the nose) of the vehicle moves downwards relative to the center of gravity of the vehicle. The nose diving phenomenon should be avoided because it plunges a driver of the vehicle forward and accordingly causes the driver to feel uncomfortable.

The nose diving phenomenon is not sufficiently suppressed by the brake force distribution for the front and rear wheels using the conventional ABFD characteristic line.

### SUMMARY OF THE INVENTION

It is therefore an object of the present invention to improve attitude of a vehicle by suppressing the elevation of the body and the nose diving phenomenon.

To this end, the inventors gave consideration to movements of a vehicle in braking.

FIG. 17 is a schematic diagram showing a spring oscillation model indicating a state of the movements during braking. As shown in the drawing, a front suspension at a front wheel is compressed by a brake force and accordingly produces an elastic force in a direction to stretch the front suspension itself. This elastic force will be hereinafter referred to as a front stretching force. In contrast, a rear suspension at a rear wheel is stretched by the brake force and accordingly produces an elastic force in a direction to compress the rear suspension itself. This elastic force will be hereinafter referred to as a rear compressing force. The front stretching force and the rear compressing force are expressed as below:

front stretching force=front brake force×anti-dive factor (=tan θ1)

and

rear compressing force=rear brake force×anti-lift factor (=tan θ2).

In the above equations, the front brake force is a brake force generated at the front wheel which depends on the W/C pressure at the W/C for the front wheel and on a friction force generated at a brake pad for the front wheel. The rear brake force is a brake force generated at the rear wheel which depends on the W/C pressure at the W/C for the rear wheel and on a friction force generated at a brake pad for the rear wheel. The anti dive factor (=tan θ1) and the anti-lift factor (=tan θ2) depends on the structure of the front and the rear suspensions, respectively. The angles θ1 and θ2 are position angles of the front suspension and rear suspension with respect to the center of rotation, respectively.

The anti-dive factor and the anti-lift factor hardly changes in a vehicle. It is therefore required to reduce the front brake force and increase the rear brake force in order to reduce the elevation of the body of the vehicle and suppress the nose diving phenomenon. This reduces the front stretching force, increases the rear compressing force, and accordingly puts the center of gravity of the body of the vehicle lower. Thus, it is possible to prevent the elevation of the body of the vehicle and suppress the nose diving phenomenon.

In an aspect of the present invention, a control portion stores an ABFD characteristic line indicating relation between a front brake force allocated to the front wheel and a rear brake force allocated to the rear wheel, wherein the ABFD characteristic line is determined based on an ideal brake force distribution characteristic line so that, in achieving a given deceleration, a ratio of the front brake force to the rear brake force becomes smaller in the case that the distribution is calculated by using the ABFD characteristic line than in the case that the distribution is calculated by using the ideal brake force distribution characteristic line.

The control portion calculates the distribution of a brake force on the front wheel and rear wheel by using the ABFD characteristic line and determines, based on the calculated distribution, the wheel cylinder pressures to be generated at the front wheel cylinder the rear wheel cylinder.

The distribution of the brake forces to the front and rear wheels are thus adjusted based on the ABFD characteristic line. The ABFD characteristic line is determined so that, in achieving a given deceleration, the ratio of the front brake force to the rear brake force becomes smaller in the case that the distribution is calculated by using the ABFD characteristic line than in the case that the distribution is calculated by using the ideal brake force distribution characteristic line. In other words, in achieving a given deceleration, the brake force distribution is more significantly weighed to the rear wheel in the case that it is calculated by using the ABFD characteristic line than in the case that it is calculated by using the ideal brake force distribution characteristic line.

Thus, it is possible to reduce the front stretching force and increase the rear compressing force, since the front brake force is reduced and the rear brake force is increased. It is therefore possible to put the center of gravity of the body of the vehicle lower, to prevent accordingly the vehicle body from moving upward exceedingly, and to suppress the nose dive phenomenon. Consequently, the attitude of the vehicle is improved.

In addition, the ABFD characteristic line to be used changes based on a first physical quantity of the vehicle including at least one of a steering angle, a change rate of the steering angle, a yaw rate, and a lateral acceleration, so that, in achieving the given deceleration, the ratio of the front brake force to the rear brake force becomes larger in the case that the first physical quantity is nonzero than in the case that the first physical quantity is zero.

In the case that a driver is operating a steering wheel of the vehicle, that a yaw of the vehicle is nonzero, or that a lateral acceleration of the vehicle is nonzero, large brake forces tend to cause the rear wheel to lock faster than the front wheel and accordingly tend to cause the vehicle to fall unstable. It is possible to keep the vehicle stable, by changing the W/C pressure for the front and rear wheels based on an amount of operation of the steering wheel performed by the driver.

For example, the actual brake force distribution characteristic line to be used can be changed based on the first physical quantity, so that, in achieving the given deceleration, the ratio of the front brake force to the rear brake force becomes larger as the first physical quantity becomes larger.

The actual brake force distribution characteristic line to be used in the case that the first physical quantity is nonzero can be changed based on a second physical quantity of the vehicle including at least on of a speed of the vehicle, a difference in rotational speed between the front wheel and the rear wheel, and an acceleration in a front-rear direction, so that, in achieving the arbitrarily given deceleration, the ratio of the front brake force to the rear brake force becomes larger in the case that the second physical quantity becomes larger.

For example, with a given physical quantity such as a steering angle, the degree of the stability of the vehicle changes depending on the speed or the lateral acceleration of the vehicle. It is therefore preferable to change the values of the W/C pressures for the front and rear wheels based on the speed or the lateral acceleration of the vehicle.

### BRIEF DESCRIPTION OF THE DRAWINGS

The invention, together with additional objective, features and advantages thereof, will be best understood from the following description, the appended claims and the accompanying drawings. In the drawings:

FIG. 1 is a schematic diagram showing an overall structure of a vehicle attitude control device according to the first embodiment of the present invention;

FIG. 2 is a detailed diagram showing portions of the vehicle attitude control device shown in FIG. 1;

FIG. 3 is a graph showing a mapping relation corresponding to an actual brake force distribution used for the vehicle attitude control device shown in FIG. 1;

FIG. 4 is a schematic diagram showing an overall structure of a vehicle attitude control device according to the second embodiment of the present invention;

FIG. 5 is a graph showing a mapping relation corresponding to an actual brake force distribution used for the vehicle attitude control device shown in FIG. 4;

FIG. 6 is a schematic diagram showing an overall structure of a vehicle attitude control device according to the third embodiment of the present invention;

FIG. 7 is a graph showing a mapping relation corresponding to an actual brake force distribution used for the vehicle attitude control device shown in FIG. 6;

FIG. 8 is a graph showing a mapping relation corresponding to an actual brake force distribution used for the vehicle attitude control device according to the fourth embodiment of the present invention;

FIG. 9 is a schematic diagram showing an overall structure of a vehicle attitude control device according to the fifth embodiment of the present invention;

FIG. 10 is a graph showing a mapping relation corresponding to an actual brake force distribution used for the vehicle attitude control device shown in FIG. 9;

FIG. 11 is a schematic diagram showing an overall structure of a vehicle attitude control device according to the sixth embodiment of the present invention;

FIG. 12 is a graph showing a mapping relation corresponding to an actual brake force distribution used for the vehicle attitude control device shown in FIG. 11;

FIG. 13 is a graph showing a mapping relation corresponding to an actual brake force distribution used for the vehicle according to the seventh to the tenth embodiments of the present invention;

FIG. 14 is a graph showing a mapping relation corresponding to an actual brake force distribution used for the vehicle according to the seventh to the eleventh embodiments of the present invention;

FIG. 15 is a graph showing a mapping relation corresponding to an actual brake force distribution used for the vehicle according to the seventh to the twelfth embodiments of the present invention;

FIG. 16 is a graph showing a mapping relation corresponding to a conventional actual brake force distribution determined based on an ideal brake force distribution; and

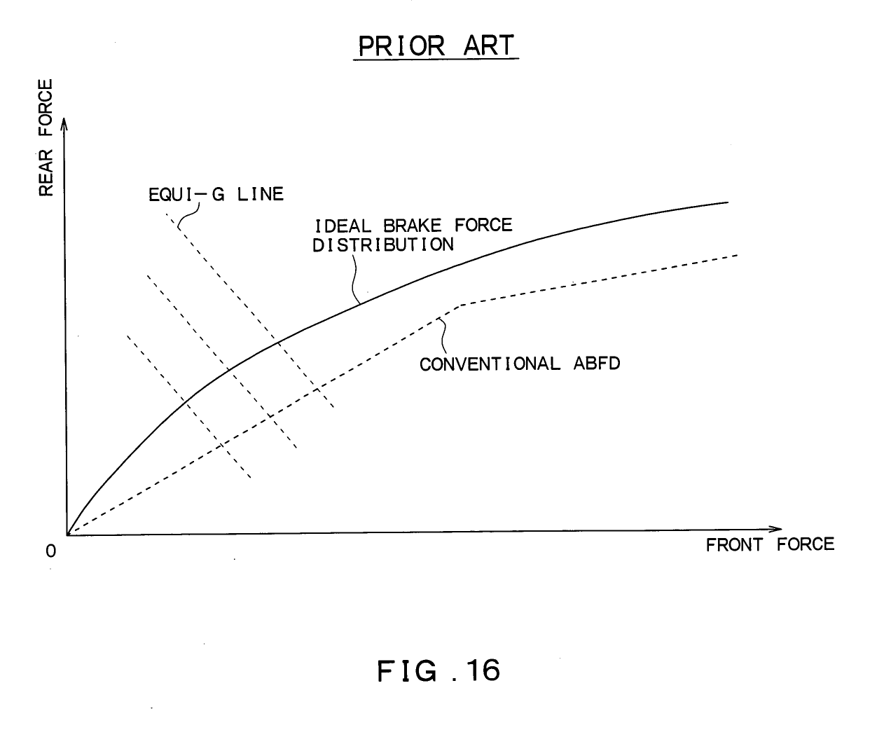

FIG. 17 is a schematic diagram showing a spring oscillation model indicating a state of movements during braking.

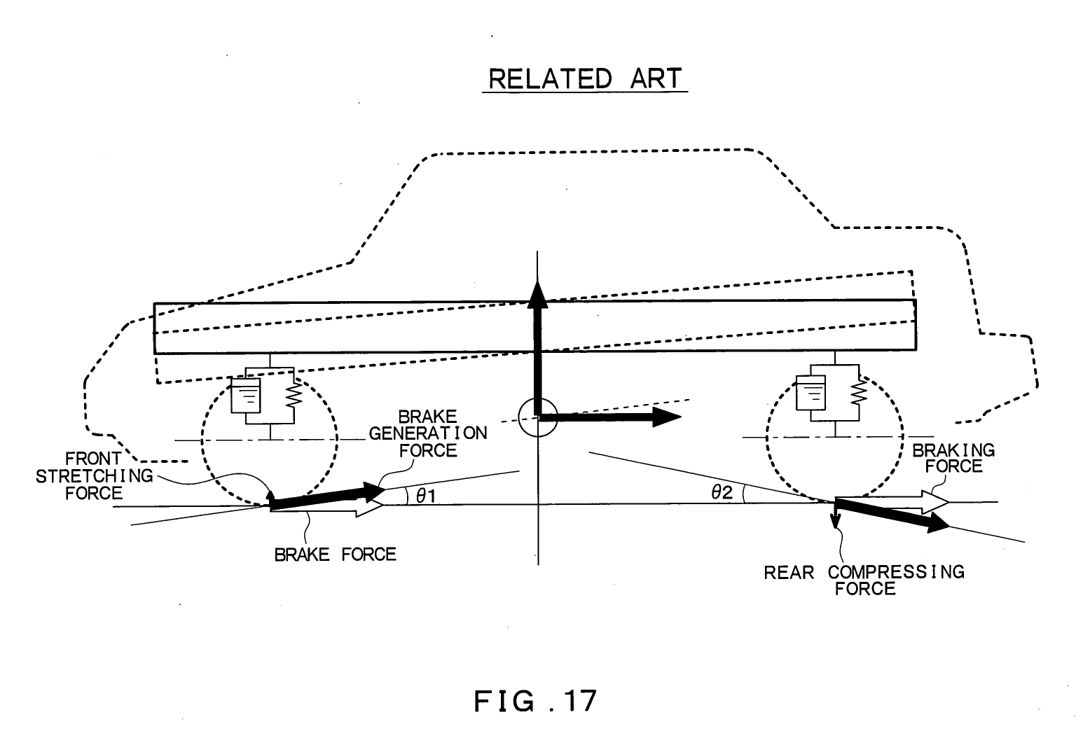

### DETAILED DESCRIPTION OF THE EMBODIMENTS

### First Embodiment

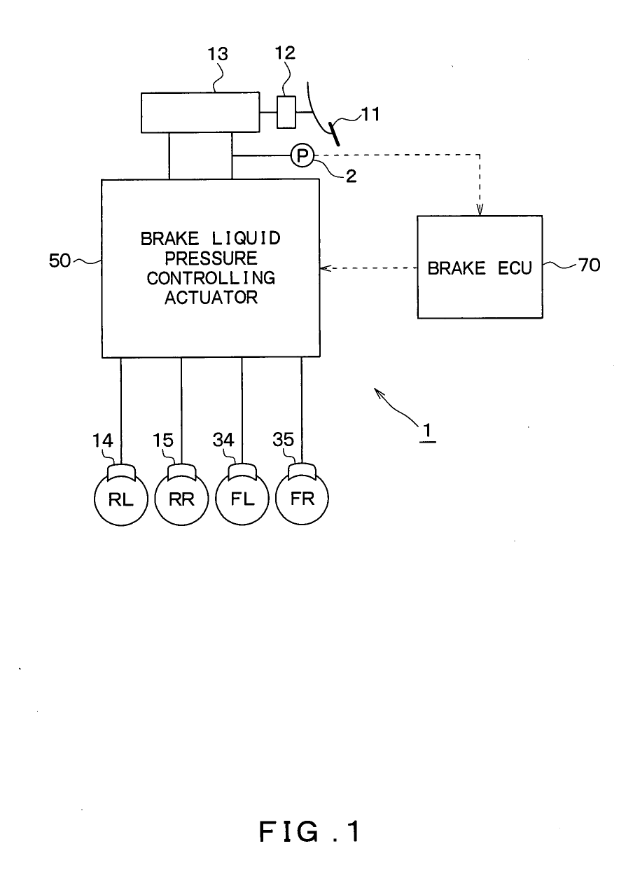

Hereinafter, a first embodiment of the present invention will be described. FIG. 1 shows an overall structure of a vehicle attitude control device 1 according to the first embodiment. The vehicle attitude control device 1 will be described with reference to FIG. 1.

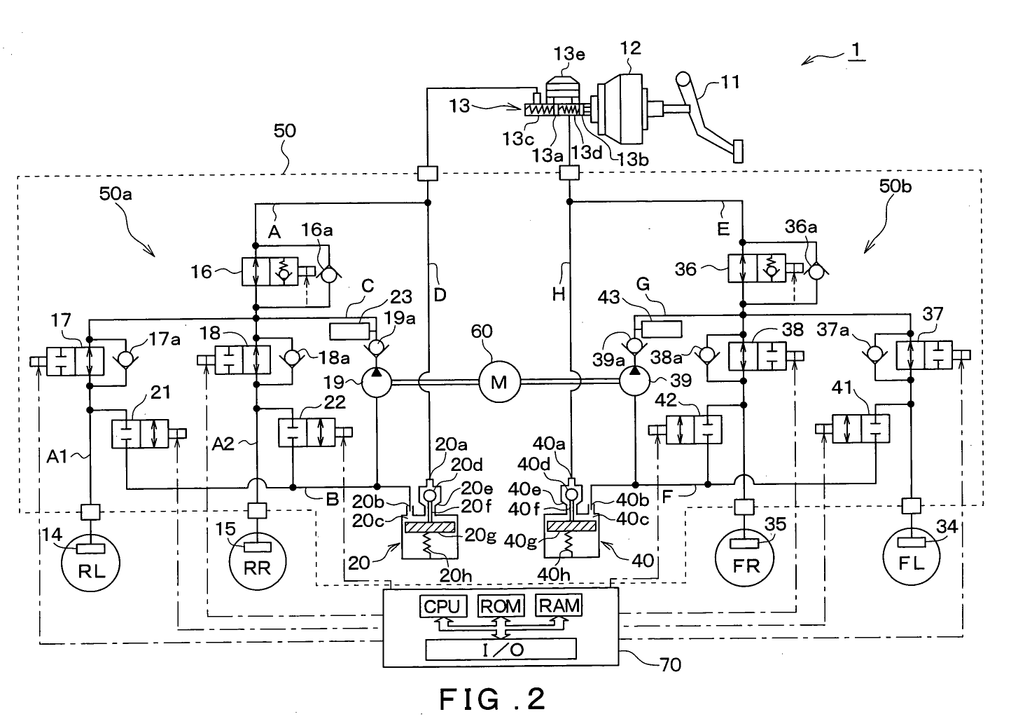

As shown in FIG. 1, the vehicle attitude control device 1 includes a brake pedal 11, a force amplifying device 12, an M/C 13, a W/C 14, a W/C 15, a W/C 34, a W/C 35, a brake liquid pressure controlling actuator (hereinafter referred to as a pressure actuator) 50, and a brake ECU 70. These portions of the vehicle attitude control device 1 are shown in detail in FIG. 2.

As shown in FIG. 2, the brake pedal 11, which is an example of a brake operating member to be depressed by a driver in applying a brake force to a vehicle, is connected with the force amplifying device 12 and the M/C 13 which are sources of generation of brake liquid pressure. When the driver depresses the brake pedal 11, the depression force is amplified by the force amplifying device 12 and presses master pistons 13a and 13b which are located in the M/C 13. Thus, M/C pressures having the same value are generated in a primary chamber 13c and a secondary chamber 13d which are zoned by the master pistons 13a and 13b.

The M/C 13 includes a master reservoir 13e which includes conduits respectively communicating with the primary chamber 13c and the secondary chamber 13d. Through the conduits, the master reservoir 13e supplies with brake liquid to the interior of the M/C 13 and retrieves excess brake liquid in the M/C 13. The conduits are shut off from the primary chamber 13c and the secondary chamber 13d when the master pistons 13a and 13b are pressed.

The M/C pressures generated in the M/C 13 are transmitted to the W/Cs 14, 15, 34, and 35 through the pressure actuator 50.

The pressure actuator 50 includes a first conduit system 50a and a second conduit system 50b. The first conduit system 50a is for controlling a brake liquid pressure applied to a rear-left wheel RL and a rear-right wheel RR. The second conduit system 50b is for controlling a brake liquid pressure applied to a front-left wheel FL and a front-right wheel FR. The first conduit system 50a and second conduit system 50b constitute a front-rear conduit system.

Hereinafter, the first conduit system 50a will be described. Descriptions of the second conduit system 50b are omitted, because the first conduit system 50a and the second conduit system 50b have very similar structures. Refer to the descriptions of first conduit system 50a below for the detailed structure of the second conduit system 50b.

The first conduit system 50a includes a conduit path serving as a main conduit path which transmits one of the M/C pressures to the W/C 14 installed to the rear-left wheel RL and the W/C 15 installed to the rear-right wheel RR. The W/C pressure is generated in the W/Cs 14 and 15 by means of the conduit path A.

In the conduit path A, a first differential pressure control valve (hereinafter referred to as a first differential valve) 16 is located which includes an electromagnetic valve switching between a communicative state and a differential pressure state. In a communicative state of a valve, brake liquid can go through the valve 16 along a conduit at which the valve is located. In the differential pressure state of a valve, a difference of brake liquid pressures between both ends of the valve is generated. In normal braking operation, the first differential valve 16 controls a position of its valve so that it switches to the communicative state. When a solenoid coil of the first differential valve 16 is supplied with an electric current, the first differential valve 16 controls the position of its valve so that it switches to the differential pressure state. The value of the difference of the brake liquid pressures between both ends of the first differential valve 16 changes based on the current value of the current supplied to the solenoid coil. More specifically, the value of the difference of the brake liquid pressures at the first differential valve 16 increases when the current value becomes greater.

In the differential pressure state of the first differential valve 16, brake liquid is allowed to flow only from the W/Cs 14, 15 side of the first differential valve 16 to the M/C 13 side of the first differential valve 16 only when the brake liquid pressure at the W/Cs 14, 15 side becomes higher than the M/C pressure by a predetermined amount. Thus, the brake liquid pressures at both ends of the first differential valve 16 are controlled in order to always keep the brake liquid pressure at the W/Cs 14, 15 side of the first differential valve 16 from becoming larger by the predetermined amount than the brake liquid pressure at the M/C 13 side of the first differential valve 16. Therefore, the conduits at both sides of the first differential valve 16 are protected.

The conduit path A branches into two conduit paths A1 and A2 at a point downstream of the W/Cs 14, 15 side of the first differential valve 16. A first pressure increasing valve 17 is located in one of the two conduit paths A1 and A2. The first pressure increasing valve 17 controls increase of the brake liquid pressure for the W/C 14. A second pressure increasing valve 18 is located in the other one of the two conduit paths A1 and A2. The second pressure increasing valve 18 controls increase of the brake liquid pressure for the W/C 15.

Each of the first pressure increasing valve 17 and the second pressure increasing valve 18 includes an electromagnetic valve and is a two-position valve switching between its communicative state and its closed state. In a closed state of a valve, brake liquid cannot go through the valve along a conduit at which the valve is located. When the first pressure increasing valve 17 and the second pressure increasing valve 18 are in the communicative states, the W/Cs 14 and 15 receive the M/C pressure or a brake liquid pressure generated by discharging of brake liquid from a pump 19 described later.

In the normal braking in which the driver operates the brake pedal 11, the first differential valve 16, the first pressure increasing valve 17, and the second pressure increasing valve 18 are always in the communicative states.

Safety valves 16a, 17a, and 18a are located respectively in parallel with the first differential valve 16, first pressure increasing valve 17, and the second pressure increasing valve 18. The safety valve 16a is for transmitting the M/C pressure to the W/Cs 14 and 15 when the brake pedal 11 is depressed by a drive even while the first differential valve 16 is in the differential pressure state. Each of the safety valves 17a and 18a is for enabling reducing, based on decrease of the depression pressure for the brake pedal 11, the W/C pressure applied to the rear-left wheel RL and the rear-right wheel RR even while a corresponding one of the first pressure increasing valve 17 and the second pressure increasing valve 18 is in the closed state because of, especially for example, ABS control.

A first depressurizing valve 21 and a second depressurizing valve 22 are located at a conduit path B which serves as a depressurizing conduit path connecting a pressure controlling reservoir 20 with a point between the first pressure increasing valve 17 and the W/C 14 and with a point between the second pressure increasing valve 18 and the W/C 15. Each of the first depressurizing valve 21 and the second depressurizing valve 22 includes an electromagnetic valve and serves as a two-position valve for switching its communicative state and its closed state. The first depressurizing valve 21 and second depressurizing valve 22 is always in the closed states in the normal braking.

A conduit path C serving as a return conduit path is located the pressure controlling reservoir 20 and the conduit path A serving as the main conduit path. A self-suction pump 19 driven by a motor 60 is installed in the conduit path C so that brake liquid is drawn in and discharged from the pressure controlling reservoir 20 to the M/C 13 side or the W/Cs 14, 15 side.

A safety valve 19a is located at the discharge side of the pump 19 so as to prevent a high brake liquid pressure from being applied to the pump 19. A fixed capacity damper 23 is installed to a portion of the conduit path C at the discharge side of the pump 19. The fixed capacity damper 23 is for damping pulsations of brake liquid discharged by the pump 19.

A conduit path D is located which connects the pressure controlling reservoir 20 with the M/C 13. The pump 19 draws in brake liquid from the M/C 13 through the conduit path D and discharges the brake liquid to the conduit path A, enabling increasing a W/C pressure of a target wheel by supplying the W/C 14 and/or the W/C 15 with the brake liquid in TCS control, ABS control, and the like.

The pressure controlling reservoir 20 includes reservoir mouths 20a and 20b. The reservoir mouth 20a is connected with the conduit path D and receives brake liquid from the M/C 13. The reservoir mouth 20b is connected with the conduit paths B and C, receives brake liquid escaping from the W/Cs 14 and 15, and supplying the intake side of the pump 19 with the brake liquid. The reservoir mouths 20a and 20b are communicated with a reservoir chamber 20c. A ball valve 20d is located deeper in the pressure controlling reservoir 20 than the reservoir mouth 20a is. A rod 20f is separatably attached to the ball valve 20d and has a predetermined stroke for moving the ball valve 20d up and down.

In the reservoir chamber 20c, a piston 20g is located which moves in conjunction with the rod 20f. In the reservoir chamber 20c, a spring 20h is also located which generates a force to press the piston 20g toward the ball valve 20d and thereby push the brake liquid out of the reservoir chamber 20c.

When the pressure controlling reservoir 20 collects a predetermined amount of the brake liquid, the ball valve 20d comes to sit on a valve seat 20e and thereby prohibits the brake liquid from flowing into the pressure controlling reservoir 20. Therefore, the brake liquid does not flow into the reservoir chamber 20c beyond intake capacity of the pump 19. Consequently, a high pressure is not applied to the intake side of the pump 19.

As described above, the second conduit system 50b has a structure very similar to that of the first conduit system 50a. More specifically, the first differential valve 16 is equivalent with a second differential pressure control valve 36. The first pressure increasing valve 17 and the second pressure increasing valve 18 are equivalent with a third pressure increasing valve 37 and the fourth pressure increasing valve 38, respectively. The first depressurizing valve 21 and the second depressurizing valve 22 are equivalent with a third depressurizing valve 41 and the fourth depressurizing valve 42, respectively. The pressure controlling reservoir 20 is equivalent with a pressure controlling reservoir 40. The pump 19 is equivalent with a pump 39. The fixed capacity damper 23 is equivalent with a damper 43. The conduit path A, conduit path B, conduit path C, and the conduit path D are equivalent with a conduit path E, a conduit path F, a conduit path G, and a conduit path H. Thus, a conduit structure for liquid pressure of the vehicle attitude control device 1 is constructed.

The vehicle attitude control device 1 also includes an M/C pressure sensor 2. A detection signal from the M/C pressure sensor 2 is outputted to the brake ECU 70.

The brake ECU 70 serves as an example of an electric control device and includes a microcomputer having a CPU, a ROM, a RAM, and an I/O. The brake ECU 70 executes processes for various calculations according to programs stored in the ROM or the like.

In the pressure actuator 50 constructed as described above, electric signals from the brake ECU 70 control electric voltages to be applied to the valves 16 to 18, 21, 22, 36 to 38, 41, 42, and the motor 60 for driving the pumps 19 and 39. The W/C pressures generated at the W/Cs 14, 15, 34, 35 are controlled in this manner.

For example, in ABS control, when the brake ECU 70 applies control voltages to the motor 60 and the solenoids for driving the electric valves, control valves 16 to 18, 21, 22, 36 to 38, 41, and 42 are driven according to the control voltages, and a path of conduits for braking is determined. Then, brake liquid pressures depending on the determined path are generated at the W/Cs 14, 15, 34, and 35. Thus, the braking forces at each of the wheels can be controlled.

Next, an operation of the vehicle attitude control device 1 will be described. Basic operation of the vehicle attitude control device 1 such as emergency braking (for example, ABS control, TCS control) is performed in a conventional manner. The operation of the vehicle attitude control device 1 in the normal braking, which is related to the present invention, will be described in detail.

When the driver depresses the brake pedal 11 and the M/C pressure is accordingly generated in the M/C 13, the M/C pressure sensor 2 outputs the detection signal depending on the generated M/C pressure. When the detection signal is inputted to the brake ECU 70, the brake ECU 70 calculates a brake force distribution on front and rear wheels FL, FR, RL, and RR. For example, the brake ECU 70 stores data of a mapping relation and calculates the brake force distribution on the front wheels FL, FR and rear wheels RL, RR based on the mapping relation.

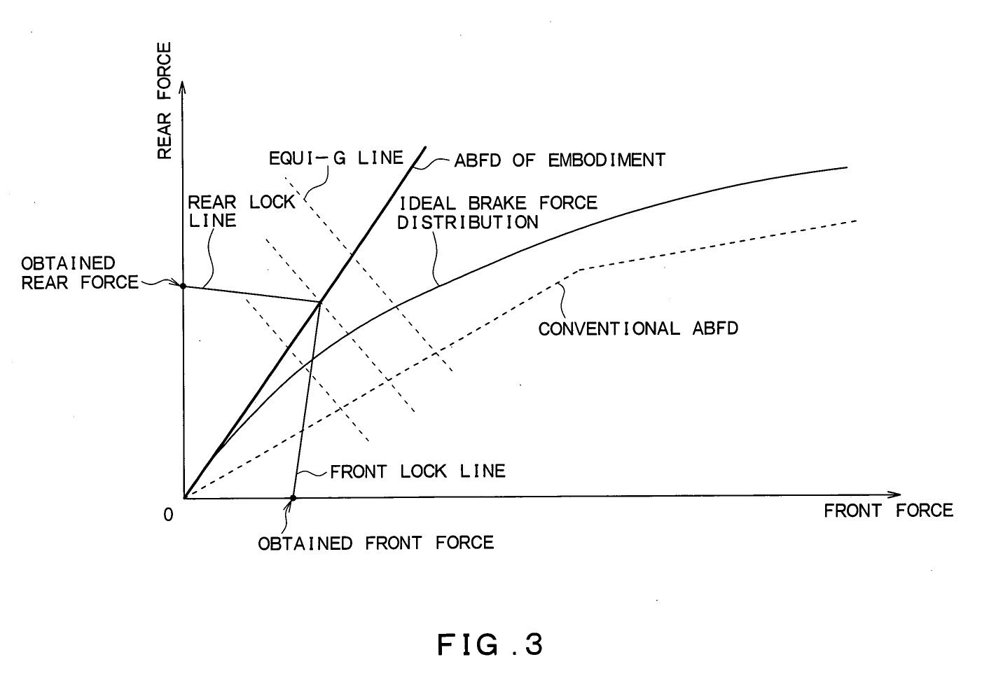

FIG. 3 shows the mapping relation indicating an actual brake force distribution used by the vehicle attitude control device 1. As shown in FIG. 3 the mapping relation includes several equi-G lines, an actual brake force distribution characteristic line (hereinafter referred to as an. ABFD characteristic line).

Each of the equi-G lines indicates a relation between values of the braking forces for the front wheels and values of the braking forces for the rear wheels for achieving a certain deceleration of the vehicle. The ABFD characteristic line shows a relation between values of the brake forces for the front wheels and values of the brake forces for the rear wheels.

An ideal brake force distribution characteristic line indicating an ideal brake force distribution is also shown in FIG. 3 as a reference. Another conventional ABFD characteristic line indicating a conventional actual brake force distribution is also shown in FIG. 3 as a reference.

On calculating the M/C pressure, the brake ECU 70 calculates, based on the calculated M/C pressure, amount of deceleration (also referred to as a deceleration G) to be applied to the vehicle. Then the brake ECU 70 uses the mapping relation stored in advance in the brake ECU 70 to determine a first cross point of the ABFD characteristic line and one of the equi-G lines corresponding to the calculated deceleration G. A second cross point of the X-axis and a front lock line extending from the first cross point is determined to be a point indicating a brake force allocated to the front wheels. A third cross point of the Y-axis and a rear lock line extending from the first cross point is determined to be a point indicating a brake force allocated to the rear wheels. The front lock line is a line beyond which the front wheels locks and slips in a certain road condition. The rear lock line is a line beyond which the rear wheels locks and slips in a certain road condition.

In achieving an arbitrarily given deceleration, a ratio of the brake force allocated to the front wheels to the total brake force (or to the brake force allocated to the rear wheels) becomes smaller in the case that the brake force distribution is calculated by using, as described above, the ABFD characteristic line than in the case that the brake force distribution is calculated by using the ideal brake force distribution characteristic line. In other words, in achieving a given deceleration, the brake force distribution is more significantly weighed to the rear wheels in the case that it is calculated by using the ABFD characteristic line than in the case that it is calculated by using the ideal brake force distribution characteristic line.

Thus, it is possible to reduce forces of front suspensions of the vehicle for extending the front suspensions themselves and to increase forces of rear suspensions of the vehicle for compressing the rear suspensions themselves, since the brake forces at the front wheels FL and FR are reduced and the brake forces at the rear wheels RL and RR are increased. It is therefore possible to put the center of gravity of the body of the vehicle lower, to prevent accordingly the vehicle body from moving upward exceedingly, and to suppress the nose dive phenomenon. Consequently, the attitude and the handling performance of the vehicle are improved and the driver accordingly does not suffer from uncomfortable feelings.

On determining the brake force distribution, the brake ECU 70 calculates current values of currents to be supplied to the first differential valve 16 and the second differential valve 36. More specifically, the brake ECU 70 calculates the W/C pressures for the W/Cs 14, 15, 34, and 35 which are necessary in order to achieve the determined the brake force distribution. The brake ECU 70 then calculates the difference of the brake liquid pressures between both ends of the first differential valve 16 which are necessary to achieve the W/C pressures for the W/Cs 14 and 15. The brake ECU 70 also calculates the difference of the brake liquid pressures between both ends of the second differential valve 36 which are necessary to achieve the W/C pressures for the W/Cs 34 and 35. The brake ECU 70 then calculates the current values for the first differential valve 16 and the second differential valve 36 which are necessary to achieve the calculated pressure differences. The pressure differences at the first differential valve 16 and the second differential valve 36 depend on the current values supplied to their solenoid coils. More specifically, the pressure differences at the first differential valve 16 and the second differential valve 36 increase as the current values supplied to their solenoid coils increase. Therefore, the calculated current values become larger as the required pressure differences become larger.

On determining the current values for the first differential valve 16 and the second differential valve 36, the brake ECU 70 supplies the currents with the determined current values to the first differential valve 16 and the second differential valve 36. Thus, the W/C pressures at the W/Cs 34 and 35 for the front wheels FL and FR becomes smaller than the W/C pressures at the W/Cs 34 and 35 for the rear wheels RL and RR. Consequently, the braking forces at the front wheels FL and FR and the rear wheels RL and RR is generated in accordance with the calculated brake force distribution.

### Second Embodiment

Hereinafter, a second embodiment of the present invention will be described. A basic structure of the vehicle attitude control device of the present embodiment is the same as that of the first embodiment. Elements of the vehicle attitude control device of this embodiment which are different from the vehicle attitude control device 1 of the first embodiment will be described below in detail.

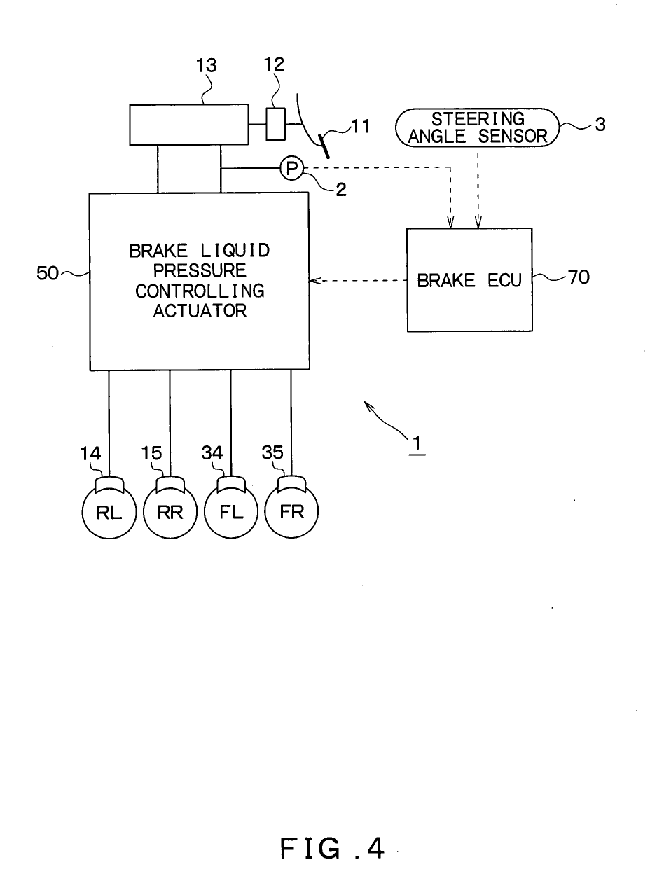

FIG. 4 shows the overall structure of the vehicle attitude control device 1 of the present embodiment. As shown in the drawing, the brake ECU 70 receives a detection signal from a steering angle sensor 3 and accordingly detects a steering angle of the vehicle.

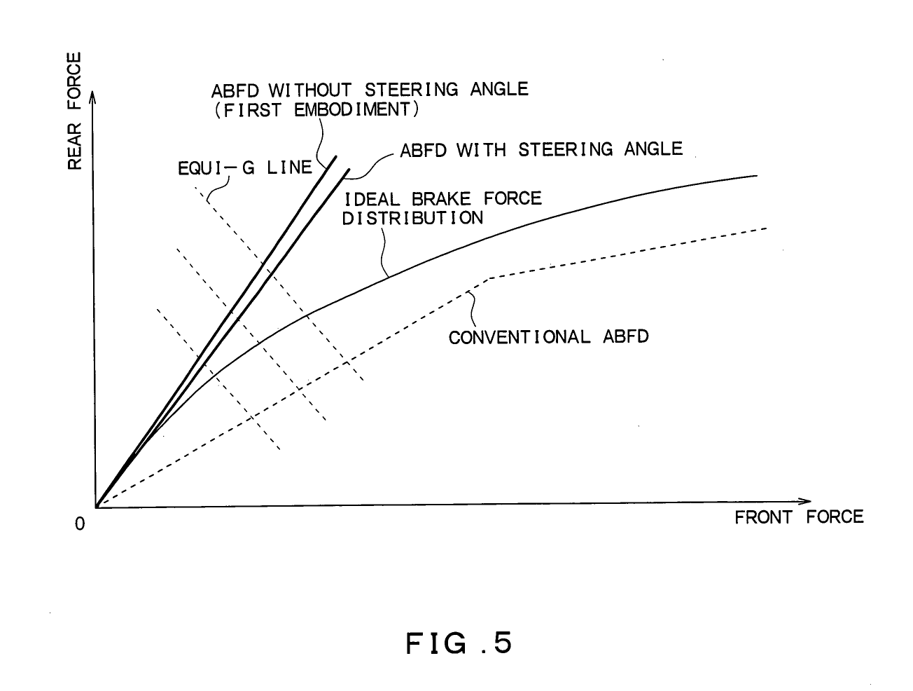

FIG. 5 shows the mapping relation indicating an actual brake force distribution used by the vehicle attitude control device 1. As shown in FIG. 5 the mapping relation includes the equi-G lines, and two ABFD characteristic lines. The ideal brake force distribution characteristic line and the conventional ABFD characteristic line are also shown in FIG. 5 as a reference.

As shown in FIG. 5, the brake ECU 70 of the present embodiment selectively uses two different ABFD characteristic lines. One of the characteristic lines is used in the case that the driver operates the steering wheel (not shown) and the steering angle is accordingly nonzero. The other one of the characteristic lines is used in the case that the driver does not operate the steering wheel (not shown) and the steering angle is accordingly zero.

In the first embodiment, in achieving a given deceleration, the brake force distribution is more significantly weighed to the rear wheels in the case that it is calculated by using the ABFD characteristic line than in the case that it is calculated by using the ideal brake force distribution characteristic line. However, large brake forces at the rear-left wheel RL and the rear-right wheel RR tend to cause the rear wheels RL and RR to lock and slip faster than the front wheels FL and FR and accordingly tend to cause the vehicle to fall unstable. Therefore, in order to keep the vehicle stable, it is preferable that the W/C pressures at the W/Cs 14, 15, 34, and 35 for the front and rear wheels FL, FR, RL, and RR changes based on an amount of operation of the steering wheel performed by the driver.

Therefore, the brake ECU 70 of the present embodiment switches, based on whether the steering angle is zero or nonzero, between using one of the two ABFD characteristic lines and using the other one, so that a ratio of the brake force allocated to the front wheels to the total brake force (or to the brake force allocated to the rear wheels) becomes larger in the case that the steering angle is nonzero than in the case that the steering angle is zero in achieving a given deceleration. In other words, in achieving a given deceleration, the brake force distribution is more significantly weighed to the front wheels in the case that the steering angle is nonzero than in the case that the steering angle is zero. As a consequence, the vehicle can travel more stably.

In this embodiment, the two ABFD characteristic lines are used for the cases that the steering angle is zero and nonzero. However, the brake ECU 70 may use a larger number of ABFD characteristic lines which are for different amounts of the steering angle, respectively.

### Third Embodiment

Hereinafter, a third embodiment of the present invention will be described. A basic structure of the vehicle attitude control device of the present embodiment is the same as that of the second embodiment. Elements of the vehicle attitude control device of this embodiment which are different from the vehicle attitude control device 1 of the second embodiment will be described below in detail.

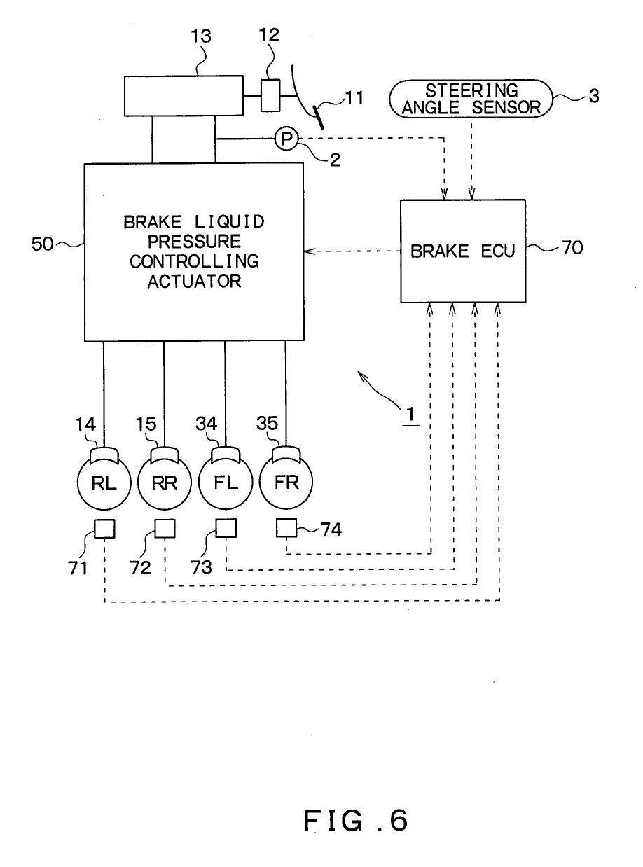

FIG. 6 shows the overall structure of the vehicle attitude control device 1 of the present embodiment. As shown in the drawing, the vehicle attitude control device 1 additionally includes wheel rotation speed sensors 71 to 74. The wheel rotation speed sensors 71 to 74 are installed respectively to wheels FL, FR, RL, and RR. Each of the wheel rotation speed sensors 71 to 74 outputs to the brake ECU 70 a pulse signal (also referred to as a detection signal) having pulses the number of which is proportional to the rotational speed of its corresponding wheel. Based on the detection signals from the wheel rotation speed sensors 71 to 74, the brake ECU 70 calculates the rotational speed of the wheels FL, FR, RL, and RR or the speed of the vehicle (hereinafter also referred to as an estimate vehicle body speed). Since methods for calculating the speed of the vehicle used by the brake ECU 70 is well-known, descriptions for the methods are omitted here.

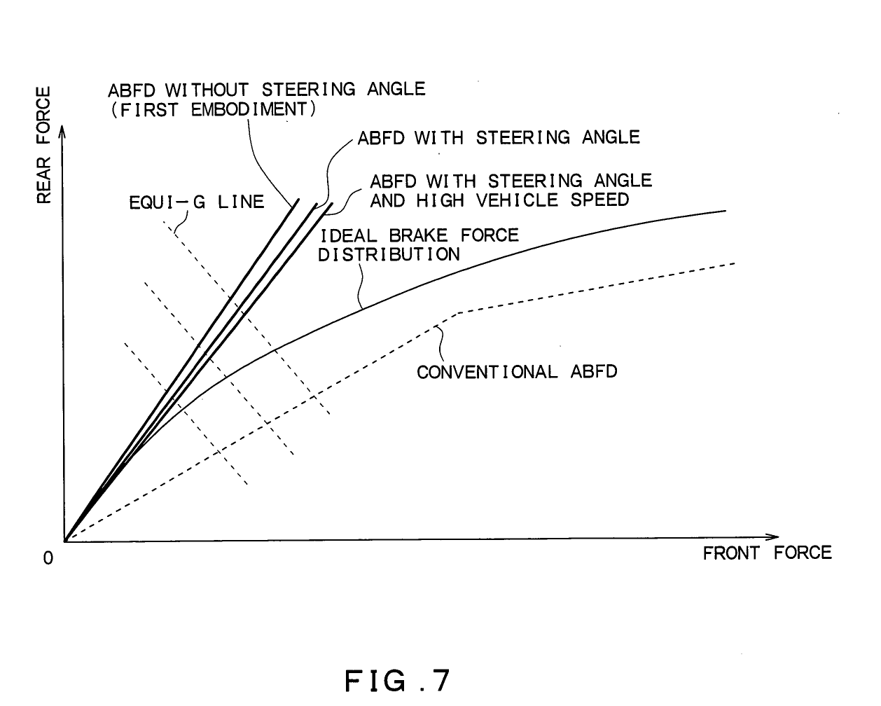

FIG. 7 shows the mapping relation indicating an actual brake force distribution used by the vehicle attitude control device 1 of the present embodiment. As shown in FIG. 7 the mapping relation includes several equi-G lines, and three ABFD characteristic lines. The ideal brake force distribution characteristic line and the conventional ABFD characteristic line are also shown in FIG. 7 as a reference.

As shown in FIG. 7, the brake ECU 70 of the present invention uses an ABFD characteristic line for the case that the steering angle is nonzero and the speed of the vehicle is higher than a threshold speed, as well as the ABFD characteristic lines for the case that the steering angle is nonzero and for the other case that the steering angle is zero, which are described in the second embodiment.

As described in the second embodiment, in order to keep the vehicle stable, it is preferable that the W/C pressures at the W/Cs 14, 15, 34, and 35 changes based on an amount of operation of the steering wheel made by the driver. Additionally, with a given steering angle, the degree of the stability of the vehicle changes depending on the speed of the vehicle. It is therefore further preferable to change the values of the W/C pressures at the W/Cs 14, 15, 34, and 35 based on the speed of the vehicle.

In the case that the steering angle is nonzero and the speed of the vehicle is larger than the threshold speed, the brake ECU 70 of the present embodiment uses the ABFD characteristic line for the case that the speed of the vehicle is larger than the threshold speed, the ABFD characteristic line being different from the ABFD characteristic line for the case that the speed of the vehicle is smaller than or equal to the threshold speed. Thus, in achieving a given deceleration, a ratio of the brake force allocated to the front wheels to the total brake force (or to the brake force allocated to the rear wheels) becomes larger in the case that the speed of the vehicle is larger than the threshold speed than in the case that the speed of the vehicle is smaller than or equal to the threshold speed. In other words, in achieving a given deceleration, the brake force distribution is more significantly weighed to the front wheels in the case that the speed of the vehicle is larger than the threshold speed than in the case that the speed of the vehicle is smaller than or equal to the threshold speed. As a consequence, the vehicle can travel more stably.

In this embodiment, the two ABFD characteristic lines are used for the case that the speed of the vehicle is larger than the threshold speed and for the case that the speed of the vehicle is smaller than or equal to the threshold speed. However, the brake ECU 70 may use a larger number of ABFD characteristic lines which are for different values of the speed of the vehicle.

### Fourth Embodiment

Hereinafter, a fourth embodiment of the present invention will be described. A basic structure of the vehicle attitude control device of the present embodiment is the same as that of the second embodiment. Elements of the vehicle attitude control device of this embodiment which are different from the vehicle attitude control device 1 of the second embodiment will be described below in detail.

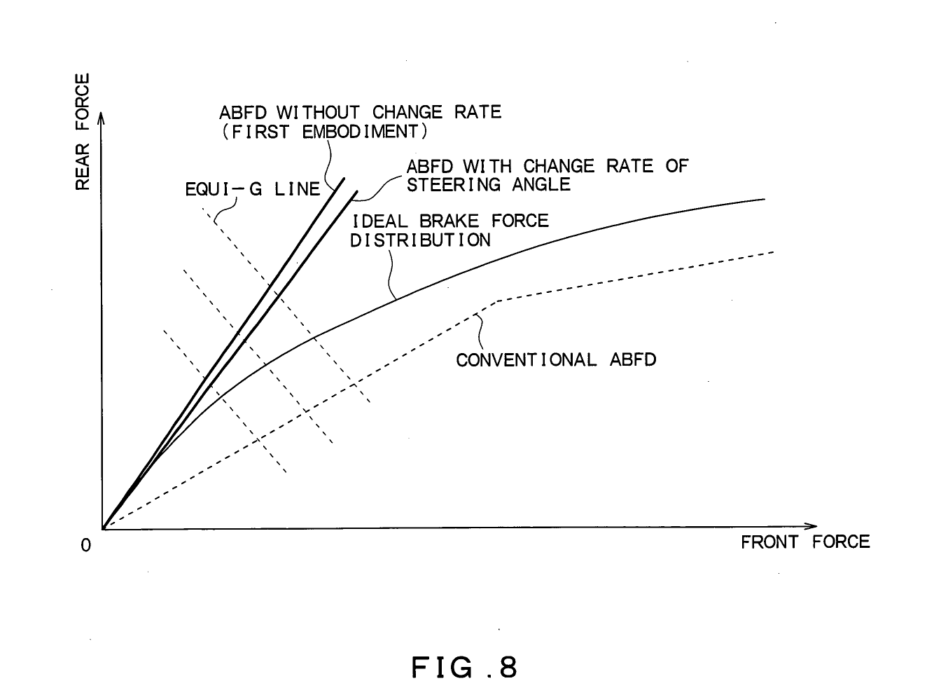

FIG. 8 shows the mapping relation indicating an actual brake force distribution used by the vehicle attitude control device 1. As shown in FIG. 8 the mapping relation includes the equi-G lines, and two ABFD characteristic lines. The ideal brake force distribution characteristic line and the conventional ABFD characteristic line are also shown in FIG. 8 as a reference.

As shown in FIG. 8, the brake ECU 70 in this embodiment selectively uses two different ABFD characteristic lines. One of the characteristic lines is used in the case that the driver operates the steering wheel (not shown) and a change rate of the steering angle is accordingly nonzero (more specifically, positive). Here, the change rate of the steering angle is defined so that it has positive value when the steering wheel is turned into a direction in which the turning radius of the vehicle decreases. The change rate of the steering angle can be detected by means of the steering angle sensor 3. The other one of the characteristic lines is used in the case that the change rate of the steering angle is zero or negative.

As described in the second embodiment, large brake forces at the rear-left wheel RL and the rear-right wheel RR tend to cause the rear wheels RL and RR to lock faster than the front wheels FL and FR and accordingly tend to cause the vehicle to fall unstable. Therefore, in order to keep the vehicle stable, it is preferable that the W/C pressures at the W/Cs 14, 15, 34, and 35 for the front and rear wheels FL, FR, RL, and RR changes based on the change rate of the steering angle.

Therefore, the brake ECU 70 of the present embodiment switches, based on whether the change rate is nonzero (more specifically, positive) or not, between using one of the two ABFD characteristic lines and using the other one, so that a ratio of the brake force allocated to the front wheels to the total brake force (or to the brake force allocated to the rear wheels) becomes larger in the case that the change rate of the steering angle is nonzero than in the case that the change rate of the steering angle is zero or negative in achieving a given deceleration. In other words, in achieving a given deceleration, the brake force distribution is more significantly weighed to the front wheels in the case that the change rate of the steering angle is nonzero than in the case that the change rate of the steering angle is zero or negative. As a consequence, the vehicle can travel more stably.

### Fifth Embodiment

Hereinafter, a fifth embodiment of the present invention will be described. A basic structure of the vehicle attitude control device of the present embodiment is the same as that of the second embodiment. Elements of the vehicle attitude control device of this embodiment which are different from the vehicle attitude control device 1 of the second embodiment will be described below in detail.

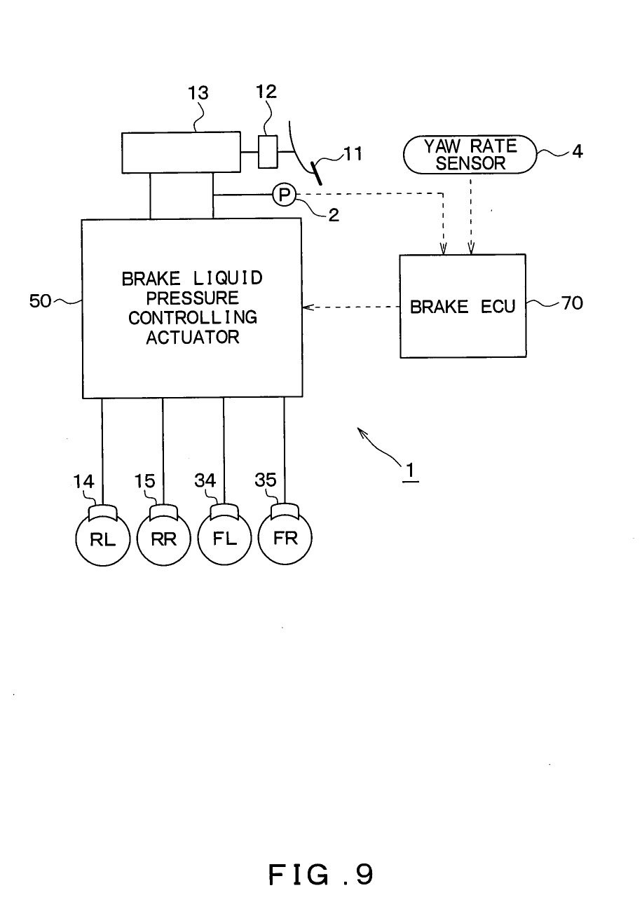

FIG. 9 shows the overall structure of the vehicle attitude control device 1 of the present embodiment. As shown in the drawing, the brake ECU 70 receives a detection signal from a yaw rate sensor 4 and accordingly detects a yaw rate of the vehicle.

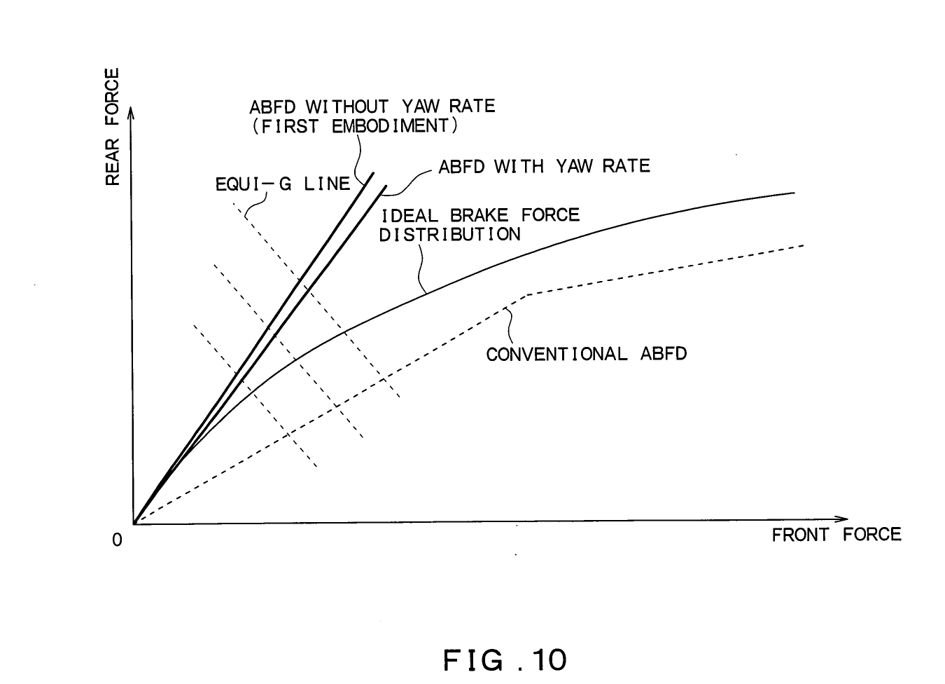

FIG. 10 shows the mapping relation indicating an actual brake force distribution used by the vehicle attitude control device 1. As shown in FIG. 10 the mapping relation includes the equi-G lines, and two ABFD characteristic lines. The ideal brake force distribution characteristic line and the conventional ABFD characteristic line are also shown in FIG. 10 as a reference.

As shown in FIG. 10, the brake ECU 70 in this embodiment selectively uses two different ABFD characteristic lines. One of the characteristic lines is used in the case that the vehicle turns and the yaw rate of the vehicle is accordingly nonzero. The other one of the characteristic lines is used in the case that the yaw rate is zero.

As described in the second embodiment, large brake forces at the rear-left wheel RL and the rear-right wheel RR tend to cause the rear wheels RL and RR to lock faster than the front wheels FL and FR and accordingly tend to cause the vehicle to fall unstable. Therefore, in order to keep the vehicle stable, it is preferable that the W/C pressures at the W/Cs 14, 15, 34, 35 for the front and rear wheels FL, FR, RL, RR changes based on the yaw rate of the vehicle.

Therefore, the brake ECU 70 of the present embodiment switches, based on whether the yaw rate is nonzero or not, between using one of the two ABFD characteristic lines and using the other one, so that a ratio of the brake force allocated to the front wheels to the total brake force (or to the brake force allocated to the rear wheels) becomes larger in the case that the yaw rate is nonzero than in the case that the yaw rate is zero in achieving a given deceleration. In other words, in achieving a given deceleration, the brake force distribution is more significantly weighed to the front wheels in the case that the yaw rate is nonzero than in the case that the yaw rate is zero. As a consequence, the vehicle can travel more stably.

### Sixth Embodiment

Hereinafter, a sixth embodiment of the present invention will be described. A basic structure of the vehicle attitude control device of the present embodiment is the same as that of the second embodiment.

Elements of the vehicle attitude control device of this embodiment which are different from the vehicle attitude control device 1 of the second embodiment will be described below in detail.

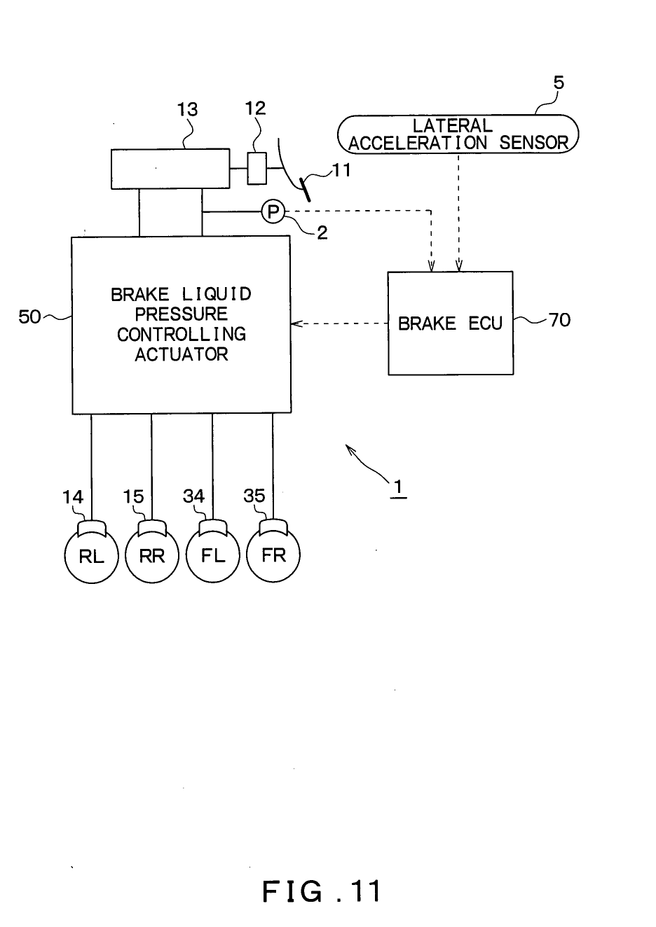

FIG. 11 shows the overall structure of the vehicle attitude control device 1 of the present embodiment. As shown in the drawing, the brake ECU 70 receives a detection signal from a lateral acceleration sensor 5 and accordingly detects an acceleration of the vehicle in the lateral direction of the vehicle.

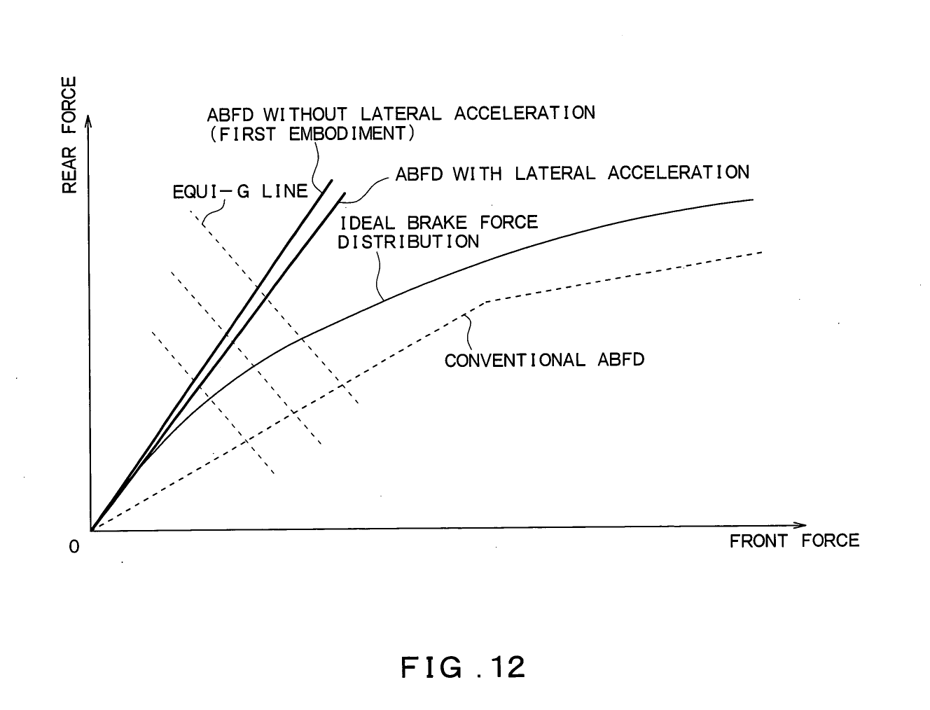

FIG. 12 shows the mapping relation indicating an actual brake force distribution used by the vehicle attitude control device 1. As shown in FIG. 12 the mapping relation includes the equi-G lines, and two ABFD characteristic lines. The ideal brake force distribution characteristic line and the conventional ABFD characteristic line are also shown in FIG. 12 as a reference.

As shown in FIG. 12, the brake ECU 70 in this embodiment selectively uses two different ABFD characteristic lines. One of the characteristic lines is used in the case that the vehicle slips in its lateral direction or turns right/left and the lateral acceleration of the vehicle is accordingly nonzero. The other one of the characteristic lines is used in the case that the lateral acceleration is zero.

As described in the second embodiment, large brake forces at the rear-left wheel RL and the rear-right wheel RR tend to cause the rear wheels RL and RR to lock faster than the front wheels FL and FR and accordingly tend to cause the vehicle to fall unstable. Therefore, in order to keep the vehicle stable, it is preferable that the W/C pressures at the W/Cs 14, 15, 34, 35 for the front and rear wheels FL, FR, RL, RR changes based on the lateral acceleration of the vehicle.

Therefore, the brake ECU 70 of the present embodiment switches, based on whether the lateral acceleration is nonzero or not, between using one of the two ABFD characteristic lines and using the other one, so that a ratio of the brake force allocated to the front wheels to the total brake force (or to the brake force allocated to the rear wheels) becomes larger in the case that the lateral acceleration is nonzero than in the case that the lateral acceleration is zero in achieving a given deceleration. In other words, in achieving a given deceleration, the brake force distribution is more significantly weighed to the front wheels in the case that the lateral acceleration is nonzero than in the case that the lateral acceleration is zero. As a consequence, the vehicle can travel more stably.

### Seventh Embodiment

Hereinafter, a seventh embodiment of the present invention will be described. A basic structure of the vehicle attitude control device of the present embodiment is the same as that of the second embodiment. Elements of the vehicle attitude control device of this embodiment which are different from the vehicle attitude control device 1 of the second embodiment will be described below in detail.

In the second embodiment, two ABFD characteristic lines are used for the cases that the steering angle is zero and nonzero. However, the brake ECU 70 of the present embodiment uses a larger number of ABFD characteristic lines which are for different amounts of the steering angle, respectively.

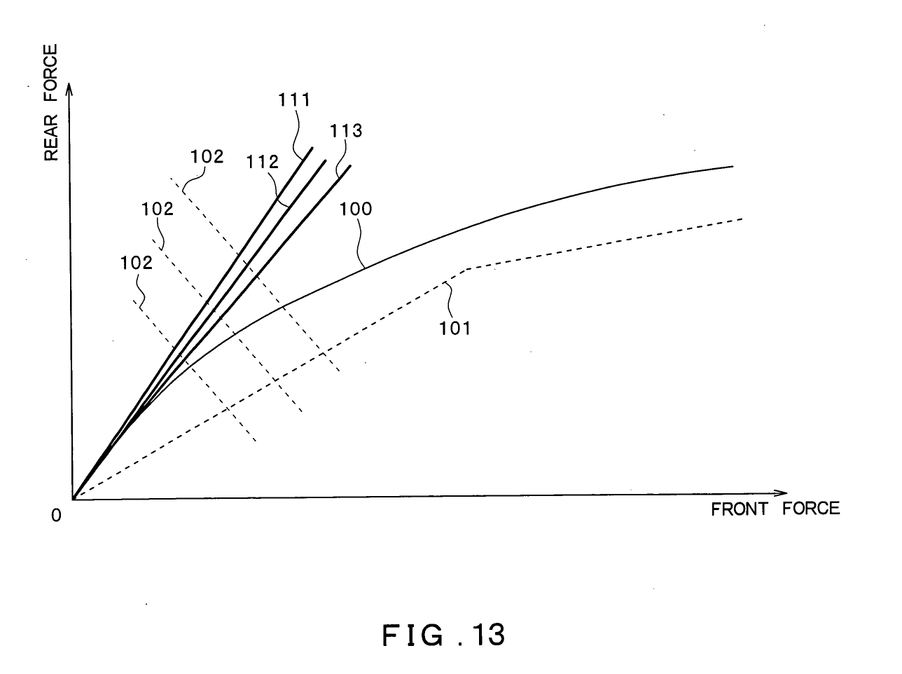

FIG. 13 shows the mapping relation indicating an actual brake force distribution used by the vehicle attitude control device 1 of the present embodiment. As shown in FIG. 13, the mapping relation includes the equi-G lines 102, and three ABFD characteristic lines 111 to 113. The ideal brake force distribution characteristic line 100 and the conventional ABFD characteristic line 101 are also shown in FIG. 13 as a reference.

As shown in FIG. 13, the brake ECU 70 in this embodiment selectively uses three different ABFD characteristic lines which correspond to different amount ranges of the steering angle. One 111 of the characteristic lines is used in the case that the driver does not operate the steering wheel and the steering angle is accordingly zero. Another one 112 of the characteristic lines is used in the case that the driver operates the steering wheel by a small amount and the steering angle is accordingly in a first range which is larger than zero. The other one 113 of the characteristic lines is used in the case that the driver operates the steering wheel by a large amount and the steering angle is accordingly in a second range which is larger than the first range. More specifically, the first range is a range which positive and smaller than a threshold angle, and the second range is a range which is larger than or equal to the threshold angle.

Therefore, based on which range the steering angle is, zero, the first range, or the second range, the brake ECU 70 of the present embodiment switches among using one of the three ABFD characteristic lines, so that a ratio of the brake force allocated to the front wheels to the total brake force (or to the brake force allocated to the rear wheels) becomes larger as the steering angle becomes larger in achieving a given acceleration. In other words, in achieving a given deceleration, the brake force distribution is more significantly weighed to the front wheels as the steering angle becomes larger. As a consequence, the vehicle can travel more stably.

The brake ECU 70 may selectively uses more than four different ABFD characteristic lines which correspond to different amount ranges of the steering angle, so that a ratio of the brake force allocated to the front wheels to the total brake force (or to the brake force allocated to the rear wheels) becomes larger as the steering angle becomes larger.

### Eighth Embodiment

Hereinafter, an eighth embodiment of the present invention will be described with reference to FIG. 13, although the ABFD characteristic lines 111, 112, and 113 in FIG. 13 are regarded as ABFD characteristic lines for different amount ranges of the change rate of the steering angle. A basic structure of the vehicle attitude control device of the present embodiment is the same as that of the fourth embodiment. Elements of the vehicle attitude control device of this embodiment which are different from the vehicle attitude control device 1 of the fourth embodiment will be described below in detail.

The brake ECU 70 of the present embodiment uses a larger number of ABFD characteristic lines which are for different amounts of the change rate of the steering angle, respectively.

As shown in FIG. 13, the brake ECU 70 in this embodiment selectively uses three different ABFD characteristic lines which correspond to different amount ranges of the change rate of the steering angle. One 111 of the characteristic lines is used in the case that the change rate is zero or negative. Another one 112 of the characteristic lines is used in the case that the change rate is in a first range which is larger than zero. The other one 113 of the characteristic lines is used in the case that the change rate is in a second range which is larger than the first range. More specifically, the first range is a range which positive and smaller than a threshold rate, and the second range is a range which is larger than or equal to the threshold rate.

Therefore, based on which range the change rate of the steering angle is, zero or negative, the first range, or the second range, the brake ECU 70 of the present embodiment switches, among using one of the three ABFD characteristic lines, so that a ratio of the brake force allocated to the front wheels to the total brake force (or to the brake force allocated to the rear wheels) becomes larger as the change rate of the steering angle becomes larger in achieving a given deceleration. In other words, in achieving a given deceleration, the brake force distribution is more significantly weighed to the front wheels as the change rate of the steering angle becomes larger. As a consequence, the vehicle can travel more stably.

The brake ECU 70 may selectively uses more than four different ABFD characteristic lines which correspond to different amount ranges of the change rate of the steering angle, so that a ratio of the brake force allocated to the front wheels to the total brake force (or to the brake force allocated to the rear wheels) becomes larger as the change rate of the steering angle becomes larger.

### Ninth Embodiment

Hereinafter, a ninth embodiment of the present invention will be described with reference to FIG. 13, although the ABFD characteristic lines 111, 112, and 113 in FIG. 13 are regarded as ABFD characteristic lines for different amount ranges of the yaw rate of the vehicle. A basic structure of the vehicle attitude control device of the present embodiment is the same as that of the fifth embodiment. Elements of the vehicle attitude control device of this embodiment which are different from the vehicle attitude control device 1 of the fifth embodiment will be described below in detail.

The brake ECU 70 of the present embodiment uses a larger number of ABFD characteristic lines which are for different amounts of the yaw rate, respectively.

As shown in FIG. 13, the brake ECU 70 in this embodiment selectively uses three different ABFD characteristic lines which correspond to different amount ranges of the yaw rate. One 111 of the characteristic lines is used in the case that the yaw rate is zero. Another one 112 of the characteristic lines is used in the case that the yaw rate is in a first range which is larger than zero. The other one 113 of the characteristic lines is used in the case that the yaw rate is in a second range which is larger than the first range. More specifically, the first range is a range which positive and smaller than a threshold yaw rate, and the second range is a range which is larger than or equal to the threshold yaw rate.

Therefore, based on which range the yaw rate is, zero, the first range, or the second range, the brake ECU 70 of the present embodiment switches among using one of the three ABFD characteristic lines, so that a ratio of the brake force allocated to the front wheels to the total brake force (or to the brake force allocated to the rear wheels) becomes larger as the yaw rate becomes larger in achieving a given deceleration. In other words, in achieving a given deceleration, the brake force distribution is more significantly weighed to the front wheels as yaw rate becomes larger. As a consequence, the vehicle can travel more stably.

The brake ECU 70 may selectively uses more than four different ABFD characteristic lines which correspond to different amount ranges of the yaw rate, so that a ratio of the brake force allocated to the front wheels to the total brake force (or to the brake force allocated to the rear wheels) becomes larger as the yaw rate becomes larger.

### Tenth Embodiment

Hereinafter, a tenth embodiment of the present invention will be described with reference to FIG. 13, although the ABFD characteristic lines 111, 112, and 113 in FIG. 13 are regarded as ABFD characteristic lines for different amount ranges of the lateral acceleration of the vehicle. A basic structure of the vehicle attitude control device of the present embodiment is the same as that of the sixth embodiment. Elements of the vehicle attitude control device of this embodiment which are different from the vehicle attitude control device 1 of the sixth embodiment will be described below in detail.

The brake ECU 70 of the present embodiment uses a larger number of ABFD characteristic lines which are for different amounts of the lateral acceleration, respectively.

As shown in FIG. 13, the brake ECU 70 in this embodiment selectively uses three different ABFD characteristic lines which correspond to different amount ranges of the lateral acceleration. One 111 of the characteristic lines is used in the case that the lateral acceleration is zero. Another one 112 of the characteristic lines is used in the case that the lateral acceleration is in a first range which is larger than zero. The other one 113 of the characteristic lines is used in the case that the lateral acceleration is in a second range which is larger than the first range. More specifically, the first range is a range which positive and smaller than a threshold lateral acceleration, and the second range is a range which is larger than or equal to the threshold lateral acceleration.

Therefore, based on which range the lateral acceleration is, zero, the first range, or the second range, the brake ECU 70 of the present embodiment switches among using one of the three ABFD characteristic lines, so that a ratio of the brake force allocated to the front wheels to the total brake force (or to the brake force allocated to the rear wheels) becomes larger as the lateral acceleration becomes larger in achieving a given deceleration. In other words, in achieving a given deceleration, the brake force distribution is more significantly weighed to the front wheels as lateral acceleration becomes larger. As a consequence, the vehicle can travel more stably.

The brake ECU 70 may selectively uses more than four different ABFD characteristic lines which correspond to different amount ranges of the lateral acceleration, so that a ratio of the brake force allocated to the front wheels to the total brake force (or to the brake force allocated to the rear wheels) becomes larger as the lateral acceleration becomes larger.

### Eleventh Embodiment

Hereinafter, an eleventh embodiment of the present invention will be described. A basic structure of the vehicle attitude control device of the present embodiment is the same as that of the third embodiment. Elements of the vehicle attitude control device of this embodiment which are different from the vehicle attitude control device 1 of the third embodiment will be described below in detail.

The brake ECU 70 of the present embodiment can receive signals from the steering angle sensor 3 shown in FIG. 4, the wheel rotation speed sensors 71 to 74 shown in FIG. 6, the yaw rate sensor 4 shown in FIG. 9, and the lateral acceleration sensor 5 shown in FIG. 11. The brake ECU 70 can detect the steering angle and the change rate of the steering angle based on the signals from the steering angle sensor 3, detect the yaw rate of the vehicle based on the signals from the yaw rate sensor 4, detect the lateral acceleration of the vehicle based on the signals from the lateral acceleration sensor 5, and detect the speed of the vehicle based on the wheel rotation speed sensors 71 to 74. The brake ECU 70 also detects a front-rear acceleration and a front-rear wheel speed difference. The front rear-acceleration is an acceleration of the vehicle in the front-rear direction and can be calculated as, for example, a time derivative of the speed of the vehicle. The front-rear wheel speed difference is a difference of the wheel speed of the front wheels from the wheel speed of the rear wheels and can be detected by the signals from the wheel rotation speed sensors 71 to 74. More specifically, the front-rear wheel speed difference has positive value when the wheel speed of the front wheel is larger than the wheel speed of the rear wheel.

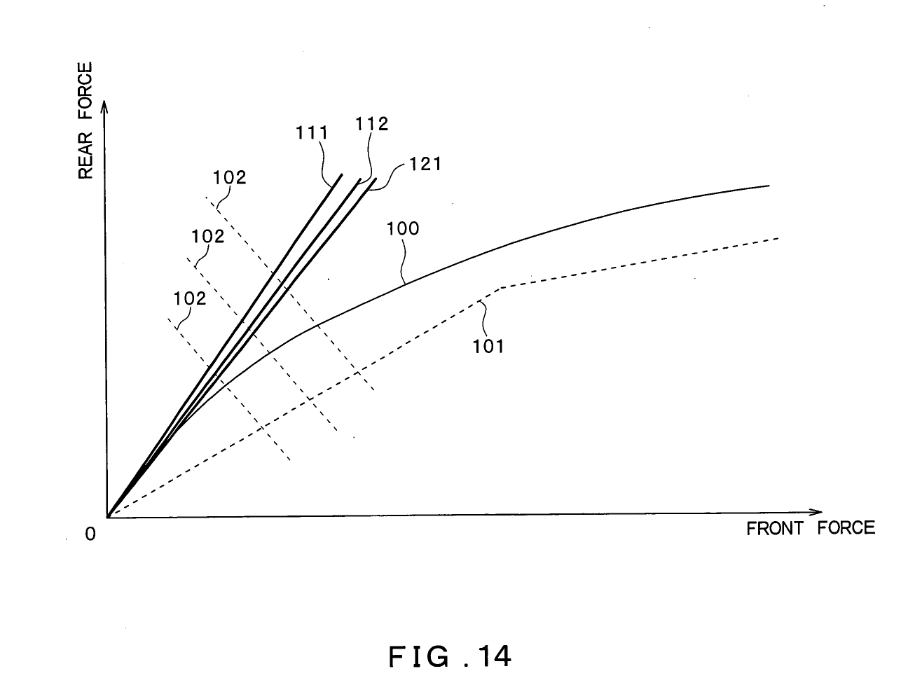

FIG. 14 shows the mapping relation indicating an actual brake force distribution used by the vehicle attitude control device 1 of the present embodiment. As shown in FIG. 14 the mapping relation includes the equi-G lines 102, and three ABFD characteristic lines 111, 112, 121. The ideal brake force distribution characteristic line 100 and the conventional ABFD characteristic line 101 are also shown in FIG. 14 as a reference.

As shown in FIG. 14, the brake ECU 70 of the present invention uses an ABFD characteristic line 121 for the case that a first physical quantity is nonzero (more specifically, positive) and a second physical quantity is larger than a threshold quantity, as well as another ABFD characteristic line 112 for the case that the first physical quantity is nonzero (more specifically, positive) and the second physical quantity is smaller than or equal to the threshold quantity and the other ABFD characteristic line 111 for the case that the first physical quantity is zero or negative.

The first physical quantity can be any one of four types of quantity including the steering angle, the change rate of the steering angle, the yaw rate, and the lateral acceleration. The second physical quantity can be any one of three types of quantity including the speed of the vehicle, the front-rear wheel speed difference, the front-rear acceleration of the vehicle. Thus, a pair of the first physical quantity and the second physical quantity can be any one of 4×3=12 combinations of the above quantities.

In the case that the first physical quantity is nonzero (more specifically, positive) and the second physical quantity is larger than the threshold quantity, the brake ECU 70 of the present embodiment uses the ABFD characteristic line 121 different from the ABFD characteristic lines 111 and 112. Thus, in achieving a given deceleration, when the first physical quantity is nonzero, a ratio of the brake force allocated to the front wheels to the total brake force (or to the brake force allocated to the rear wheels) becomes larger in the case that the second physical quantity is larger than the threshold quantity than in the case that the second physical quantity is smaller than or equal to the threshold quantity. In other words, in achieving a given deceleration, when the first physical quantity is nonzero, the brake force distribution is more significantly weighed to the front wheels in the case that the second physical quantity is larger than the threshold quantity than in the case that the second physical quantity is smaller than or equal to the threshold quantity. As a consequence, the vehicle can travel more stably.

In this embodiment, the two ABFD characteristic lines are used for the case that the second physical quantity is larger than the threshold quantity and for the case that second physical quantity is smaller than or equal to the threshold quantity6. However, the brake ECU 70 may use a larger number of ABFD characteristic lines which are for different values of the second physical quantity.

### Twelfth Embodiment

Hereinafter, a twelfth embodiment of the present invention will be described. A basic structure of the vehicle attitude control device of the present embodiment is the same as that of the eleventh embodiment. Elements of the vehicle attitude control device of this embodiment which are different from the vehicle attitude control device 1 of the eleventh embodiment will be described below in detail.

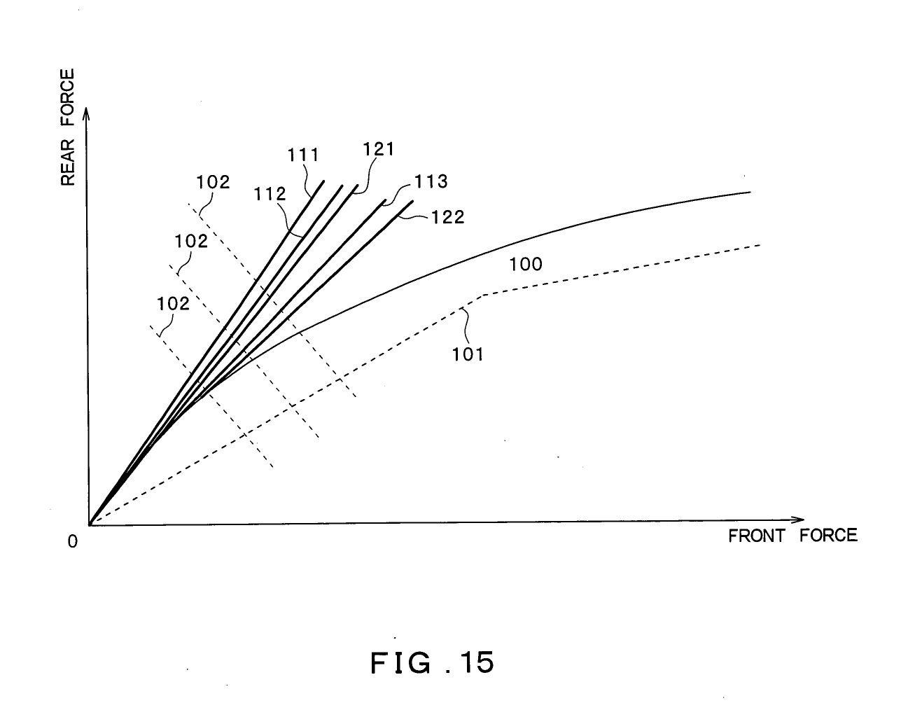

FIG. 15 shows the mapping relation indicating an actual brake force distribution used by the vehicle attitude control device 1 of the present embodiment. As shown in FIG. 15 the mapping relation includes the equi-G lines 102, and five ABFD characteristic lines 111 to 113, 121, 122. The ideal brake force distribution characteristic line 100 and the conventional ABFD characteristic line 101 are also shown in FIG. 15 as a reference.

As shown in FIG. 15, the brake ECU 70 of the present invention uses five ABFD characteristic lines 111 to 113, 121, and 122. The ABFD characteristic line 111 is for the case that the first physical quantity is zero or negative. The ABFD characteristic line 112 is for the case that the first physical quantity is positive but smaller than a first threshold quantity and that the second physical quantity is smaller than a second threshold quantity. The ABFD characteristic line 113 is for the case that the first physical quantity is larger than or equal to the first threshold quantity and that the second physical quantity is smaller than the second threshold quantity. The ABFD characteristic line 121 is for the case that the first physical quantity is positive but smaller than the first threshold quantity and that the second physical quantity is larger than or equal to the second threshold quantity. The ABFD characteristic line 122 is for the case that the first physical quantity is larger than or equal to the first threshold quantity and that the second physical quantity is larger than or equal to the second threshold quantity.

The first physical quantity can be any one of four types of quantity including the steering angle, the change rate of the steering angle, the yaw rate, and the lateral acceleration. The second physical quantity can be any one of three types of quantity including the speed of the vehicle, the front-rear wheel speed difference, the front-rear acceleration of the vehicle. Thus, a pair of the first physical quantity and the second physical quantity can be any one of 4×3=12 combinations of the above quantities.

Thus, in achieving a given deceleration, a ratio of the brake force allocated to the front wheels to the total brake force (or to the brake force allocated to the rear wheels) becomes larger as the first physical quantity or the second physical quantity becomes larger. In other words, in achieving a given deceleration, the brake force distribution is more significantly weighed to the front wheels as the first physical quantity or the second physical quantity becomes larger. As a consequence, the vehicle can travel more stably.

In this embodiment, the two ABFD characteristic lines are used for the case that the first physical quantity is larger than or equal to the first threshold quantity and for the case that first physical quantity is smaller than the threshold quantity. However, the brake ECU 70 may use a larger number of ABFD characteristic lines which are for different values of the first physical quantity.

Similarly, the two ABFD characteristic lines are used for the case that the second physical quantity is larger than or equal to the threshold quantity and for the case that second physical quantity is smaller than the threshold quantity. However, the brake ECU 70 may use a larger number of ABFD characteristic lines which are for different values of the second physical quantity.

### Other Embodiment

The present invention should not be limited to the embodiment discussed above and shown in the figures, but may be implemented in various ways without departing from the spirit of the invention.

In some of the above embodiments, the brake ECU 70 stores the data of the mapping relation indicating one or more ABFD characteristic lines. However, the brake ECU 70 may store calculation formulae equivalent to the one or more ABFD characteristic lines and may calculate, by means of the formulae, the brake force distribution for the front wheels FL, FR and the rear wheels RL, RR when the deceleration is determined.

In the second embodiment, the ABFD characteristic lines are selectively used based on the steering angle. However, ABFD characteristic lines may be selectively used based on a physical quantity other than the steering angle such as a change rate of the steering angle, a yaw rate of the vehicle, and a lateral acceleration of the vehicle. In this case, not only two ABFD characteristic lines but also more than two ABFD characteristic lines can be used for different amounts for the physical quantity.

In the third embodiment, the ABFD characteristic lines are selectively used based on the speed of the vehicle when the steering angle is nonzero. However, ABFD characteristic lines can be selectively used based on the acceleration of the vehicle in the front-rear direction (hereinafter referred to as a front-rear acceleration). In addition, the ABFD characteristic lines are selectively used based on the speed or the front-rear acceleration of the vehicle in the case that the change rate of the steering angle is zero, in the case that the change rate of the steering angle is nonzero, in the case that the yaw rate of the vehicle is zero, in the case that the yaw rate of the vehicle is nonzero, in the case that the lateral acceleration of the vehicle is zero, or in the case that the lateral acceleration of the vehicle is nonzero.

In the above embodiments, the steering angle and the speed of the vehicle are calculated by the brake ECU 70. However, the steering angle or the speed of the vehicle can be obtained through on-vehicle LAN if another ECU installed in the vehicle calculates the steering angle or the speed of the vehicle.

In the above embodiments, the speed of the vehicle is calculated by means of detection signals from the wheel rotational speed sensors 71 to 74. However, the speed of the vehicle may be calculated by means of a signal from a vehicle speed sensor installed in the vehicle. In the case that the brake ECU 70 receives signals (that is, information) indicating the speed of the vehicle, a portion which outputs the signals serves as an example of a means for detecting the speed of the vehicle.

In the above embodiment, a brake actuator for the vehicle attitude control device 1 is the brake liquid pressure controlling actuator 50 having a hydraulic circuit which pressurizes the W/Cs 14, 15, 34, and 35 by means of the brake liquid pressures and generates brake forces at drive axle wheels and the wheels other than the drive axle wheels. However, an electrical brake actuator can be used which electrically operates to pressurize the W/Cs 14, 15, 34, and 35. In this case, a motor or the like serves as a brake control actuator when the motor or the like pressurizes the W/Cs 14, 15, 34, and 35 based on a control signal outputted by the brake ECU 70.

In the above embodiments, the brake pedal 11 is used as an example of the brake operating member. However, a brake lever can be used as an example of the brake operating member.

What is claimed is:

1. A vehicle attitude control device for controlling attitude of a vehicle, comprising:
a control portion for:
calculating a deceleration of the vehicle according to an amount of an operation of a brake operating member performed by a driver;
calculating a distribution of a brake force on a front wheel of the vehicle and a rear wheel of the vehicle based on the calculated deceleration; and
determining wheel cylinder pressures to be generated at a front wheel cylinder installed to the front wheel and a rear wheel cylinder installed to the rear wheel; and
an actuator for controlling the front wheel cylinder and the rear wheel cylinder to achieve the determined wheel cylinder pressures,
wherein:
the control portion:
stores an actual brake force distribution characteristic line indicating relation between a front brake force allocated to the front wheel and a rear brake force allocated to the rear wheel, wherein the actual brake force distribution characteristic line is determined based on an ideal brake force distribution characteristic line so that, in achieving a given deceleration, a ratio of the front brake force to the rear brake force becomes smaller in the case that the distribution is calculated by using the actual brake force distribution characteristic line than in the case that the distribution is calculated by using the ideal brake force distribution characteristic line;
calculates the distribution by using the actual brake force distribution characteristic line; and
determines, based on the calculated distribution, the wheel cylinder pressures to be generated at the front wheel cylinder the rear wheel cylinder; and
the actual brake force distribution characteristic line to be used changes based on a first physical quantity of the vehicle including at least one of a steering angle, a change rate of the steering angle, a yaw rate, and a lateral acceleration, so that, in achieving the given deceleration, the ratio of the front brake force to the rear brake force becomes larger in the case that the first physical quantity is nonzero than in the case that the first physical quantity is zero.

2. The vehicle attitude control device according to claim 1, wherein the actual brake force distribution characteristic line to be used changes based on the first physical quantity, so that, in achieving the given deceleration, the ratio of the front brake force to the rear brake force becomes larger as the first physical quantity becomes larger.

3. The vehicle attitude control device according to claim 1, wherein the actual brake force distribution characteristic line to be used in the case that the first physical quantity is nonzero changes based on a second physical quantity of the vehicle including at least one of a speed of the vehicle, a difference in rotational speed between the front wheel and the rear wheel, and an acceleration in a front-rear direction, so that, in achieving the given deceleration, the ratio of the front brake force to the rear brake force becomes larger in the case that the second physical quantity becomes larger.

4. The vehicle attitude control device according to claim 2, wherein the actual brake force distribution characteristic line to be used in the case that the first physical quantity is nonzero changes based on a second physical quantity of the vehicle including at least one of a speed of the vehicle, a difference in rotational speed between the front wheel and the rear wheel, and an acceleration in a front-rear direction, so that, in achieving the given deceleration, the ratio of the front brake force to the rear brake force becomes larger in the case that the second physical quantity becomes larger.
